(19) United States
(12) Patent Application Publication
(10) Pub. No.: US 2020/0224006 A1
(43) Pub. Date: Jul. 16, 2020

(54) FLAME-RETARDANT POLYAMIDE MOLDING COMPOUNDS

(71) Applicant: BASF SE, Ludwigshafen am Rhein (DE)

(72) Inventors: Roland Helmut Kraemer, Shanghai (CN); Sebastian Wagner, Ludwigshafen (DE)

(21) Appl. No.: 16/497,197

(22) PCT Filed: Mar. 26, 2018
(86) PCT No.: PCT/EP2018/057652

§ 371 Date: Sep. 24, 2019

(30) Foreign Application Priority Data
Mar. 28, 2017 (EP) 17163318.3

(51) Int. Cl. C08K 13/02; C08K 13/04; C08J 3/20; C08J 5/10; C08L 77/06

(52) U.S. Cl. CPC C08K 13/02; C08K 13/04; C08J 3/203; C08J 5/10; B29C 48/022; C08J 2377/06; C08L 2205/025; C08L 2205/03; C08L 2201/02; C08L 77/06

(57) ABSTRACT

The disclosed thermoplastic molding material includes a specific combination of at least three flame retardant additives in addition to at least one thermoplastic polyamide and glass fibers. In some embodiments, the present invention has for its object the provision of specific mixtures of flame retardant input materials which result in glass fiber reinforced polyamide molding materials which pass not only the UL 94 requirements but also the glow wire test in its various forms and can also be processed without discoloration.

The invention relates to glass fiber reinforced thermoplastic molding materials based on polyamide and endowed with flame retardant properties.

Flame retardants for thermoplastic polymers are known per se. DE-A 199 60 671 describes customary flame retardants such as phosphinic acid salts and melamine compounds.

JP 2014-152322 describes flame retardant glass fiber reinforced polyamide resins which comprise organophosphinates, melamine polyphosphates and phosphazene compounds as flame retardant additives. The molding materials listed in the examples comprise 55.0 wt % of glass fibers, 2.5 to 3.0 wt % of phosphazene compounds, 0.5 to 1.0 wt % of melamine polyphosphate and 10.0 to 15.0 wt % of DEPAL. The molding material according to example 2 comprises 3.0 wt % of PA 6, 23.0 wt % of PA 66, 5.0 wt % of PA 6T/6I, 10.0 wt % of DEPAL, 1.0 wt % of melamine polyphosphate, 3.0 wt % of phosphazene compound and 55.0 wt % of glass fibers. UL 94 test results for sheets of 0.8 mm in thickness are listed. Glow wire tests were not performed.

While such molding materials do pass the UL 94 tests for test specimens of 0.4 mm and 0.8 mm in thickness they do not pass the glow wire test on the actual component part, for example a plug having a different wall thickness. When using the amount of phosphazene compounds and melamine polyphosphate required to pass the component part test an undesired interaction of both components occurs that causes black colorations in the material and results in the formation of volatile compounds which makes processing into high-quality component parts impossible.

The present invention has for its object the provision of specific mixtures of flame retardant input materials which result in glass fiber reinforced polyamide molding materials which pass not only the UL 94 requirements but also the glow wire test in its various forms and can also be processed without discoloration.

The object is achieved in accordance with the invention by a mixture consisting of 1.0 to 10.0, preferably 2.0 to 6.0 parts by weight of at least one phosphazene of general formula (IX) or (X)

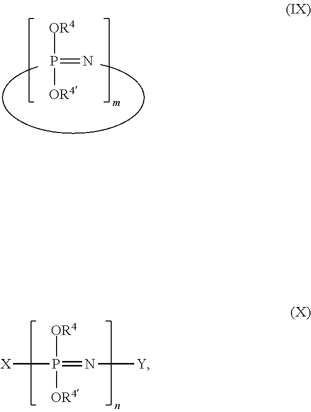

in which m is an integer from 3 to 25 and R⁴ and R^{4′} are identical or different and represent C₁-C₂₀-alkyl-, C₆-C₃₀-aryl-, C₆-C₃₀-arylalkyl- or C₆-C₃₀-alkyl-substituted aryl,

n represents 3 to 1000 and X represents —N═P(OPh)₃ or −N═P(O)OPh and Y represents —P(OPh)₄ or —P(O)(OPh)₂,

as component B,

1.0 to 6.0 parts by weight of at least one aliphatic or aromatic ester of phosphoric acid or polyphosphoric acid as component C,

5.0 to 30.0 parts by weight of at least one metal phosphinate or phosphinic acid salt of general formula (I) or diphosphinic acid salt of general formula (II) or polymers thereof

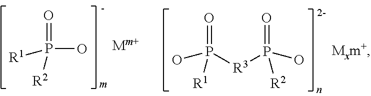

in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or -arylalkylene;
M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4, preferably m=3, x=3,
as component D.

The total of components B, C and D sums to 100.0 wt %, thus there are no other or further components or ingredients. The mixture exists of the components B, C and D. The invention also relates to the use thereof for endowing glass fiber reinforced polyamide molding materials with flame retardant properties.

The object is also achieved by a thermoplastic molding material comprising
a) 25.0 to 64.5 wt % of at least one thermoplastic polyamide as component A,
b) 1.0 to 10.0 wt % of at least one phosphazene of general formula (IX) or (X)

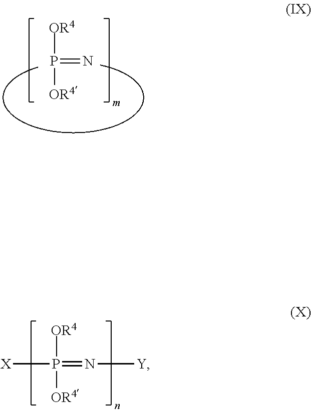

in which m is an integer from 3 to 25 and R⁴ and R^{4′} are identical or different and represent C₁-C₂₀-alkyl-, C₆-C₃₀-aryl-, C₆-C₃₀-arylalkyl- or C₆-C₃₀-alkyl-substituted aryl or linear phosphazenes of general formula (X),
n represents 3 to 1000 and X represents —N═P(OPh)₃ or —N═P(O)OPh and Y represents —P(OPh)₄ or —P(O)(OPh)₂,
as component B,
c) 1.0 to 6.0 wt % of at least one aliphatic or aromatic ester of phosphoric acid or polyphosphoric acid as component C,
d) 5.0 to 30.0 wt % of at least one metal phosphinate or phosphinic acid salt of general formula (I) or diphosphinic acid salt of general formula (II) or polymers thereof

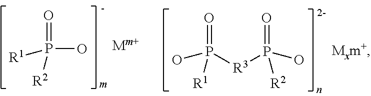

in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or -arylalkylene;
M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4, preferably m=3, x=3,
as component D,
e) 26.0 to 65.0 wt % of glass fibers as component E,
f) 0 to 10.0 wt % of further assistants as component F,
   wherein the total of components A to E sums to 100.0 wt %.

It is preferable when neither the mixture according to the invention nor the molding material according to the invention comprise melamine polyphosphate (MPP) as is elucidated hereinbelow.

The object is also achieved by a process for producing such thermoplastic molding materials by mixing the ingredients, by using the thermoplastic molding materials for producing molded articles, fibers or films, by molded articles, fibers or films made of such a thermoplastic molding material and by processes for producing molded articles, fibers or films from this molding material by melting, extruding and subsequent molding of the thermoplastic molding material.

Also, at a content of more than 6.0 wt % of the flame retardant melamine compounds the UL 94 test is no longer passed.

According to one embodiment of the invention the molding materials of the invention do not contain melamine cyanurate. Preferably, the molding materials of the invention contain at most 5.0 wt %, more preferably at most 2,0 wt %, specifically no flame-retardant melamine compounds like melamine polyphosphate and melamine cyanurate.

It has been found in accordance with the invention that at a proportion of phosphazene of 2.0 to 8.0 wt % in combination with 1.5 to 6.0 wt % of at least one aliphatic or aromatic ester of phosphoric acid or polyphosphoric acid in a thermoplastic molding material all requirements of the glow wire test and UL 94 test can be fulfilled and homogeneous materials having a light hue are achieved. The glass fiber proportion is at least 26.0 wt %.

Only a specific combination of components B to D as the flame retardant system thereby affords an advantageous profile of properties which results in the fulfillment of both the component part test and the UL 94 test at 0.4 mm and 0.8 mm for the molding materials/component parts (GWT).

As a result for component parts made of the thermoplastic molding materials according to the invention the glow wire test can be passed on the actual component part without ignition while the UL 94 test is simultaneously fulfilled in all wall thicknesses. In addition the good mechanical properties of the molding materials/the molded articles produced therefrom are retained.

The advantages of the mixture employed in accordance with the invention are achieved in particular for molding materials based on polyamides which comprise at least 26.0 wt %, preferably at least 29.0%, in particular at least 30.0 wt % of glass fibers.

The individual components of the mixture employed in accordance with the invention and of the thermoplastic molding materials are more particularly elucidated hereinbelow.

The proportions reported below are based on the total of components A to E which sums to 100 wt % (independently of the presence of further components whose quantity is likewise based on the total of components A to E).

The individually recited lower limits and upper limits for the individual components may be combined with one another freely. The thus formed subcombinations also form part of the subject matter of the present invention.

As component A the thermoplastic molding materials comprise 25.0 to 64.5 wt %, by preference 26.5 to 61.5 wt %, preferably 25.0 to 56.0 wt %, in particular 41.0 to 52.0 wt %, of at least one thermoplastic polyamide.

The polyamides of the molding materials according to the invention generally have a viscosity number of 90 to 350, preferably 110 to 240, ml/g determined in a 0.5 wt % solution in 96.0 wt % sulfuric acid at 25° C. in accordance with ISO 307.

Semicrystalline or amorphous resins having a molecular weight (weight average) of at least 5000, such as are described for example in U.S. Pat. Nos. 2,071,250, 2,071,251, 2,130,523, 2,130,948, 2,241,322, 2,312,966, 2,512,606 and 3,393,210, are preferred.

Examples thereof include polyamides derived from lactams having 7 to 13 ring members, such as polycaprolactam, polycaprylolactam and polylaurolactam and also polyamides obtained by reacting dicarboxylic acids with diamines.

Usable dicarboxylic acids are alkanedicarboxylic acids having 6 to 12 and in particular 6 to 10 carbon atoms and aromatic dicarboxylic acids. Mention is made here, as acids, only of adipic acid, azelaic acid, sebacic acid, dodecanedioic acid and terephthalic and/or isophthalic acid.

Particularly suitable diamines are alkanediamines having 6 to 12, in particular 6 to 8, carbon atoms and m-xylylenediamine, di(4-aminophenyl)methane, di(4-aminocyclohexyl)methane, 2,2-di(4-aminophenyl)propane, 2,2-di(4-aminocyclohexyl)propane or 1,5-diamino-2-methylpentane.

Preferred polyamides are polyhexamethylene adipamide, polyhexamethylene sebacamide, polycaprolactam and the nylon-6/66 copolyamides, in particular with a proportion of from 5 to 95.0% by weight of caprolactam units.

Further suitable polyamides are obtainable from w-aminoalkylnitriles, for example aminocapronitrile (PA 6) and adipodinitrile with hexamethylenediamine (PA 66) by so-called direct polymerization in the presence of water, as described in DE-A 10313681, EP-A 1 198 491 and EP 9 220 65 for example.

Mention is also made of polyamides obtainable, for example, by condensation of 1,4-diaminobutane with adipic acid at elevated temperature (polyamide-4,6). Production processes for polyamides having this structure are described in EP-A 38 094, EP-A 38 582 and EP-A 039 524 for example.

Also suitable are polyamides obtainable by copolymerization of two or more of the abovementioned monomers or mixtures of a plurality of polyamides in any desired mixing ratio.

Furthermore, semiaromatic copolyamides such as PA 6/6T and PA 66/6T having a triamine content of by preference less than 0.5 wt %, preferably less than 0.3 wt % have proven suitable (see EP-A 299 444 and EP-A 667 367).

Suitable copolyamides are constructed from:
A1) 20.0 to 90.0 wt % of units derived from terephthalic acid and hexamethylenediamine,
A2) 0 to 50.0 wt % of units derived from ε-caprolactam,
A3) 0 to 80.0 wt % of units derived from adipic acid and hexamethylenediamine,
A4) 0 to 40.0 wt % of further polyamide-forming monomers, wherein the proportion of component (A2) or (A3) or (A4) or mixtures thereof is at least 10.0 wt %.

Component A1) comprises 20.0 to 90.0 wt % of units derived from terephthalic acid and hexamethylenediamine.

In addition to the units derived from terephthalic acid and hexamethylenediamine, the copolyamides optionally comprise units derived from ε-caprolactam and/or units derived from adipic acid and hexamethylenediamine and/or units derived from further polyamide-forming monomers.

Aromatic dicarboxylic acids A4) comprise 8 to 16 carbon atoms. Suitable aromatic dicarboxylic acids include, for example, isophthalic acid, substituted terephthalic and isophthalic acids such as 3-t-butylisophthalic acid, polycyclic dicarboxylic acids, for example 4,4′- and 3,3′-diphenyldicarboxylic acid, 4,4′- and 3,3′-diphenylmethanedicarboxylic acid, 4,4′- and 3,3′-sulfodiphenylcarboxylic acid, 1,4- or 2,6-naphthalenedicarboxylic acid, phenoxyterephthalic acid, isophthalic acid being particularly preferred.

Further polyamide-forming monomers A4) may be derived from dicarboxylic acids having 4 to 16 carbon atoms and aliphatic or cycloaliphatic diamines having 4 to 16 carbon atoms and also from aminocarboxylic acids/corresponding lactams having 7 to 12 carbon atoms. As examples of suitable monomers of these types mention is made here only of suberic acid, azelaic acid and sebacic acid as representatives of aliphatic dicarboxylic acids, 1,4-butanediamine, 1,5-pentanediamine, piperazine, 4,4′-diaminodicyclohexylmethane, 2,2-(4,4′-diaminodicyclohexyl)propane and 3,3′-dimethyl-4,4′-dianninodicyclohexylnnethane or meta-xylylenediamine as representatives of diamines and caprolactam, enantholactam, ω-aminoundecanoic acid and laurolactam as representatives of lactams/aminocarboxylic acids.

Suitable such copolyamides are more particularly elucidated in DE-A-10 2009 011 668.

The following nonexhaustive list contains the polyamides mentioned and also further polyamides within the meaning of the invention, and the monomers present.

AB polymers:

| | |
|---|---|
| PA 4 | pyrrolidone |
| PA 6 | ε-caprolactam |
| PA 7 | ethanolactam |
| PA 8 | caprylolactam |
| PA 9 | 9-aminopelargonic acid |
| PA 11 | 11-aminoundecanoic acid |
| PA 12 | laurolactam |

AA/BB polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1212 | 1,12-dodecanediamine, decanedicarboxylic acid |
| PA 1313 | 1,13-diaminotridecane, undecanedicarboxylic acid |
| PA6T | hexamethylenediamine, terephthalic acid |
| PA MXD6 | m-xylylenediamine, adipic acid |

AA/BB polymers:

| | |
|---|---|
| PA6I | hexamethylenediamine, isophthalic acid |
| PA 6-3-T | trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 61 and PA 6T) |
| PAPACM 12 | diaminodicyclohexylmethane, laurolactam |
| PA 6I/6T/PACMT | as PA 6I/6T + diaminodicyclohexylmethane, |
| | terephthalic acid |
| PA 6T/6I/MACMT | as PA 6I/6T + dimethyldiaminocyclohexylmethane, |
| | terephthalic acid |
| PA 6T/6I/MXDT | as PA 6I/6T + m-xylylenediamine, |
| | terephthalic acid |
| PA 12/MACMI | laurolactam, dimethyldiaminodicyclohexylmethane, |
| | isophthalic acid |
| PA 12/MACMT | laurolactam, dimethyldiaminodicyclohexylmethane, |
| | terephthalic acid |
| PA PDA-T | phenylenediamine, terephthalic acid |

Component A is preferably a blend of at least one aliphatic polyamide and at least one semi-aromatic or aromatic polyamide.

Particularly preferably employed as component A in accordance with the invention are mixtures comprising polyamide-6 and polyamide-6.6 and optionally also polyamide-6I/6T. It is preferable to employ a main amount of polyamide-6.6. The amount of polyamide-6 is preferably 5.0 to 50.0 wt %, particularly preferably 10.0 to 30.0 wt %, based on the amount of polyamide-6.6. In the event of co-use of polyamide-6I/6T the proportion thereof is preferably 10.0 to 25.0 wt %, particularly preferably 0 to 25.0 wt %, based on the amount of polyamide-6.6.

In addition to or instead of polyamide-6I/6T, polyamide-6I or polyamide-6T or mixtures thereof may also be employed.

As component B the thermoplastic molding materials preferably comprise 1.0 to 10.0 wt %, preferably 2.0 to 6.0, in particular 3.0 to 5.0 wt %, of at least one phosphazene of general formula (IX) or (X).

The minimum amount of component B is at least 1.0 wt %, preferably 2.0 wt %, in particular 3.0 wt %.

The maximum amount of component B is 10.0 wt %, preferably 6.0 wt %, particularly preferably 5.0 wt %.

“Phosphazenes” is to be understood as meaning cyclic phosphazenes of general formula (IX)

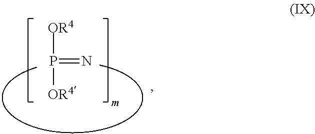

in which m is an integer from 3 to 25 and R⁴ and R⁴′ are identical or different and represent C₁-C₂₀-alkyl-, C₆-C₃₀-aryl-, C₆-C₃₀-arylalkyl- or C₆-C₃₀-alkyl-substituted aryl or linear phosphazenes of general formula (X)

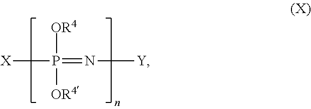

in which n represents 3 to 1000 and X represents —N═P(OPh)₃ or —N═P(O)OPh and Y represents —P(OPh)₄ or —P(O)(OPh)₂.

The production of such phosphazenes is described in EP-A 0 945 478.

Particular preference is given to cyclic phenoxyphosphazenes of formula P₃N₃C₃₆ of formula (XI)

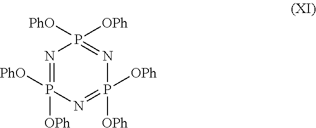 [SMILES: c1ccc(OP2(Oc3ccccc3)=NP(Oc3ccccc3)(Oc3ccccc3)=NP(Oc3ccccc3)(Oc3ccccc3)=N2)cc1]

or linear phenoxyphosphazenes according to formula (XII)

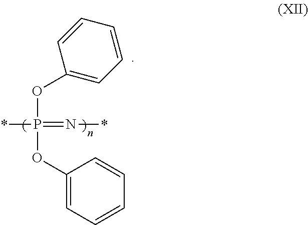

The phenyl radicals may optionally be substituted. Phosphazenes in the context of the present application are described in Mark, J. A., Allcock, H. R., West, R., “Inorganic Polymers”, Prentice Hall International, 1992, pages 61 to 141.

Preferably employed as component B are cyclic phenoxyphosphazenes having at least three phenoxyphosphazene units. Corresponding phenoxyphosphazenes are described for example in US 2010/0261818 in paragraphs [0051] to [0053]. Reference may in particular be made to formula (I) therein. Corresponding cyclic phenoxyphosphazenes are furthermore described in EP-A-2 100 919, in particular in paragraphs [0034] to [0038] therein. Production may be effected as described in EP-A-2 100 919 in paragraph [0041]. In one embodiment of the invention the phenyl groups in the cyclic phenoxyphosphazene may be substituted by C₁₋₄-alkyl radicals. It is preferable when pure phenyl radicals are concerned.

For further description of the cyclic phosphazenes reference may be made to Rompp Chemie-Lexikon, 9th ed., keyword “phosphazenes”. Production is effected for example via cyclophosphazene which is obtainable from PCl₅ and NH₄Cl, wherein the chlorine groups in the cyclophosphazene have been replaced by phenoxy groups by reaction with phenol.

The cyclic phenoxy phosphazene compound may for example be produced as described in “Phosphorus-Nitrogen Compounds” (Academic Press, 1972), H. R. Allcock and “Inorganic Polymers” (Prentice Hall International, Inc., 1992), J. E. Mark, H. R. Allcock and R. West.

Component B is preferably a mixture of cyclic phenoxyphosphazenes having three and four phenoxy phosphazene units. The weight ratio of rings comprising three phenoxyphosphazene units to rings comprising four phenoxyphosphazene units is preferably about 80:20. Larger rings of the phenoxyphosphazene units may likewise be present but in smaller amounts. Suitable cyclic phenoxyphosphazenes are obtainable from Fushimi Pharmaceutical Co., Ltd., under the name Rabitle® FP-100. This is a matt-white/yellowish solid having a melting point of 110° C., a phosphorus content of 13.4% and a nitrogen content of 6.0%. The proportion of rings comprising three phenoxyphosphazene units is at least 80.0 wt %.

As component C the thermoplastic molding materials preferably comprise 1.0 to 6.0 wt %, preferably 2.5 to 5.5 wt %, in particular 3.0 to 5.0 wt %, of at least one aliphatic or aromatic ester of phosphoric acid or polyphosphoric acid.

For this reason especially solid, non-migrating phosphate esters having a melting point between 70° C. and 150° C. are preferred. This has the result that the products are easy to meter and exhibit markedly less migration in the molding material. Particularly preferred examples are the commercially available phosphate esters PX-200® (CAS: 139189-30-3) from Daihachi, or Sol-DP® from ICL-IP. Further phosphate esters with appropriate substitution of the phenyl groups are conceivable when this allows the preferred melting range to be achieved. The general structural formula, depending on the substitution pattern in the ortho position or the para position on the aromatic ring, is as follows:

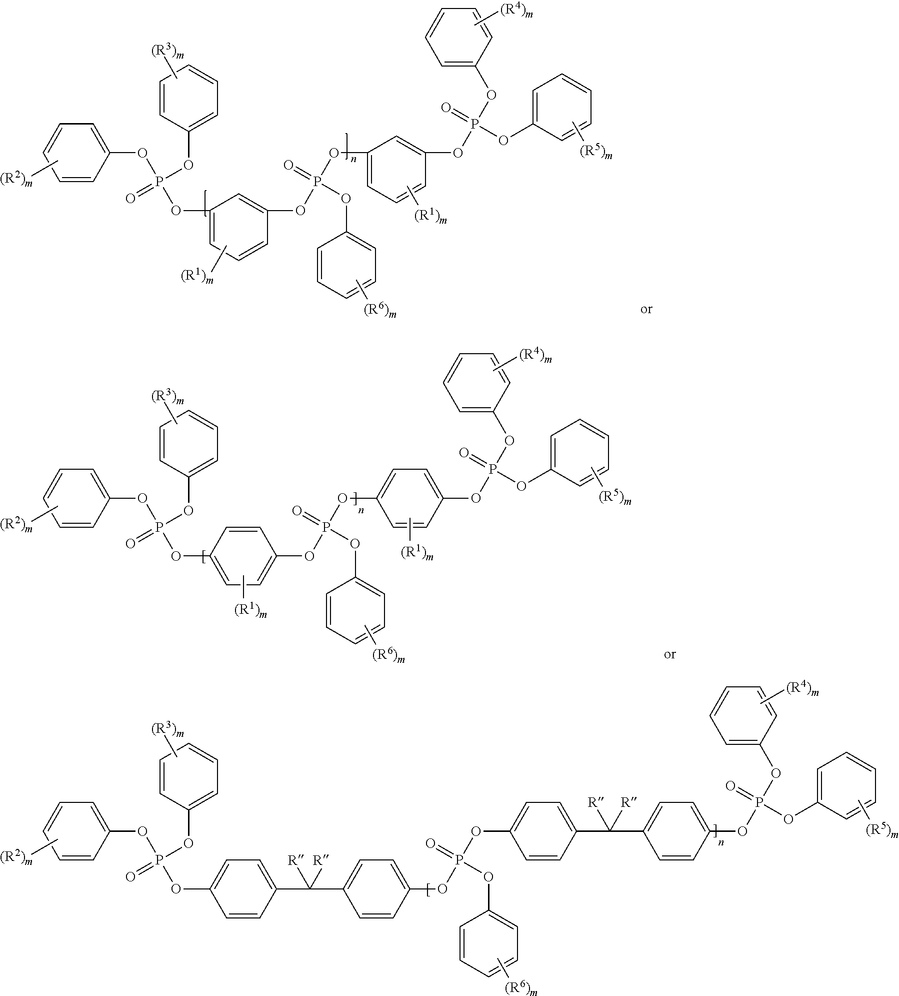

wherein
R¹=H, methyl, ethyl or isopropyl, but preferably H.
n=between 0 and 7, but preferably 0.
R²⁻⁶=H, methyl, ethyl or isopropyl, but preferably methyl. R⁶ is preferably identical to R⁴ and R⁵.
m=may be but need not be identical and is between 1, 2, 3, 4 and 5, but preferably 2.
R″=may be H, methyl, ethyl or cyclopropyl, but preferably methyl and H.

PX-200 is given as a concrete example:

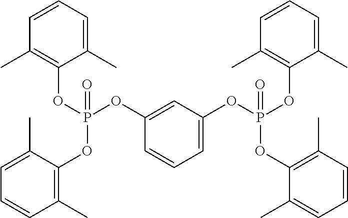 [SMILES: Cc1cccc(C)c1OP(=O)(Oc1cccc(OP(=O)(Oc2c(C)cccc2C)Oc2c(C)cccc2C)c1)Oc1c(C)cccc1C]

It is particularly preferable when at least one aromatic ester of polyphosphoric acid is employed. Such aromatic polyphosphates are obtainable for example from Daihachi Chemical under the name PX-200.

As component D the thermoplastic molding materials according to the invention comprise 5.0 to 30.0 wt %, preferably 10.0 to 25.0 wt %, in particular 12.0 to 20.0 wt %, for example about 16.0 wt %, of at least one metal phosphinate or phosphinic acid salt described hereinbelow.

The minimum amount of component D is 5.0 wt %, preferably 10.0 wt %, in particular 12.0 wt %.

The maximum amount of component D is 30.0 wt %, preferably 25.0 wt %, particularly preferably 20.0 wt %.

Examples of preferred flame retardants of component D are metal phosphinates derived from hypophosphorous acid. A metal salt of hypophosphorous acid with Mg, Ca, Al or Zn as the metal may be employed for example. Particular preference is given here to aluminum hypophosphite.

Also suitable are phosphinic acid salts of formula (I) or/and diphosphinic acid salts of formula (II) or polymers thereof

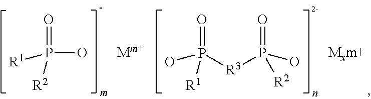

in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or -arylalkylene;
M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4, preferably m=3, x=3.

Preferably, R¹, R² are identical or different and represent hydrogen, methyl, ethyl, n-propyl, isopropyl, n-butyl, tert.-butyl, n-pentyl and/or phenyl.

Preferably, R³ represents methylene, ethylene, n-propylene, isopropylene, n-butylene, tertbutylene, n-pentylene, n-octylene or n-dodecylene, phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

Particularly preferably, R¹, R² is hydrogen, methyl, ethyl and M=Al, particular preference being given to Al hypophosphite.

Production of the phosphinates is preferably effected by precipitation of the corresponding metal salts from aqueous solutions. However, the phosphinates may also be precipitated in the presence of a suitable inorganic metal oxide or sulfide as support material (white pigments, for example TiO₂, SnO₂, ZnO, ZnS, SiO₂). This accordingly affords surface-modified pigments which can be employed as laser-markable flame retardants for thermoplastic polyesters.

It is preferable when metal salts of substituted phosphinic acids are employed in which compared to hypophosphorous acid one or two hydrogen atoms have been replaced by phenyl, methyl, ethyl, propyl, isobutyl, isooctyl or radicals R′—CH—OH have been replaced by R′-hydrogen, phenyl, tolyl. The metal is preferably Mg, Ca, Al, Zn, Ti, Fe. Aluminum diethylphosphinate (DE-PAL) is particularly preferred.

For a description of phosphinic acid salts or diphosphinic acid salts reference may be made to DE-A 199 60 671 and also to DE-A 44 30 932 and DE-A 199 33 901.

As component E the thermoplastic molding materials comprise 28.0 to 80.0 wt %, preferably 29.0 to 60.0 wt %, in particular 30.0 to 39.0 wt %, of glass fibers.

These may be customary glass fibers which may be employed in the form of endless fibers or chopped glass fibers. Said fibers may be uncoated or coated, for example coated with a silane size.

Co-usable as component F are 0 to 10.0 wt %, preferably 0 to 5.0 wt %, in particular 0 to 3.0 wt % of further assistants. The amount is based on the total of components A to E. In the event of co-use of further assistants the minimum amount thereof is preferably 0.5 wt %, particularly preferably at least 1.0 wt %, in particular at least 1.5 wt %. The further assistants may be further additives or processing aids.

Suitable are for example mineral fillers such as talc, magnesium hydroxide, Wollastonite needles, lubricants such as ester waxes and oxidized polyethylene waxes, stabilizers such as antioxidants, light stabilizers, phenols, phosphites and phosphonites or acid scavengers, nucleating agents, carbon blacks or pigments such as white pigments, for example TiO₂, ZnO, ZrO₂, SnO₂, ZnS.

Also contemplated as component F are further flame retardants, for example halogen-containing flame retardants.

Suitable halogen-containing flame retardants are preferably brominated compounds, such as brominated diphenyl ether, brominated trimethylphenylindane (FR 1808 from DSB) tetrabromobisphenol A and hexabromocyclododecane.

Suitable flame retardants are preferably brominated compounds, such as brominated oligocarbonates (BC 52 or BC 58 from Great Lakes) having the structural formula:

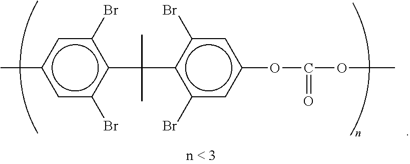

Especially suitable are polypentabromobenzyl acrylates where n>4 (e.g. FR 1025 from ICL-IP having the formula:

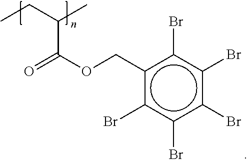

Preferred brominated compounds further include oligomeric reaction products (n>3) of tetrabromobisphenol A with epoxides (e.g. FR 2300 and 2400 from DSB) having the formula:

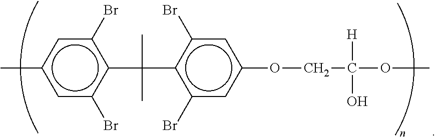

The brominated oligostyrenes preferably employed as flame retardants have an average degree of polymerization (number-average) between 3 and 90, preferably between 5 and 60, measured by vapor pressure osmometry in toluene. Cyclic oligomers are likewise suitable. In a preferred embodiment of the invention the brominated oligomeric styrenes have the formula I shown below in which R represents hydrogen or an aliphatic radical, in particular an alkyl radical, for example CH₂ or C₂H₅, and n represents the number of repeating chain building blocks. R¹ may be H or else bromine or else a fragment of a customary free radical former:

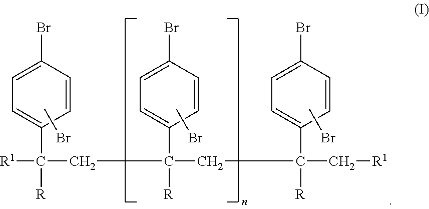

The value n may be 1 to 88, preferably 3 to 58. The brominated oligostyrenes comprise 40.0 to 80.0 wt %, preferably 55.0 to 70.0 wt %, of bromine. Preference is given to a product consisting predominantly of polydibromostyrene. The substances are meltable without decomposing, and soluble in tetrahydrofuran for example. Said substances may be produced either by ring bromination of—optionally aliphatically hydrogenated—styrene oligomers such as are obtained for example by thermal polymerization of styrene (according to DT-OS 25 37 385) or by free-radical oligomerization of suitable brominated styrenes. The production of the flame retardant may also be effected by ionic oligomerization of styrene and subsequent bromination. The amount of brominated oligostyrene necessary for endowing the polyamides with flame retardant properties depends on the bromine content. The bromine content in the molding materials according to the invention is from 2.0 to 30.0 wt %, preferably from 5.0 to 12.0 wt %.

The brominated polystyrenes according to the invention are typically obtained by the process described in EP-A 047 549:

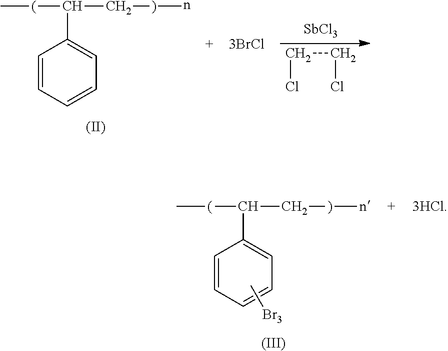

The brominated polystyrenes obtainable by this process and commercially available are predominantly ring-substituted tribrominated products. n′ (see III) generally has values of 125 to 1500 which corresponds to a molecular weight of 42,500 to 235,000, preferably of 130,000 to 135,000.

The bromine content (based on the content of ring-substituted bromine) is generally at least 50.0 wt %, preferably at least 60.0 wt % and in particular 65.0 wt %.

The commercially available pulverulent products generally have a glass transition temperature of 160° C. to 200° C. and are for example obtainable under the names HP 7010 from Albemarle and Pyrocheck PB 68 from Ferro Corporation.

Mixtures of the brominated oligostyrenes with brominated polystyrenes may also be employed in the molding materials according to the invention, the mixing ratio being freely choosable.

Also suitable are chlorine-containing flame retardants, Declorane plus from Oxychem being preferable.

Suitable halogen-containing flame retardants are preferably ring-brominated polystyrene, brominated polybenzyl acrylates, brominated bisphenol A epoxide oligomers or brominated bisphenol A polycarbonates.

In one embodiment of the invention no halogen-containing flame retardants are employed in the thermoplastic molding materials according to the invention.

A flame retardant melamine compound suitable as component F in the context of the present invention is a melamine compound which when added to glass fiber filled polyamide molding materials reduces flammability and influences fire behavior in a fire retarding fashion, thus resulting in improved properties in the UL 94 tests and in the glow wire test.

The melamine compound is for example selected from melamine borate, melamine phosphate, melamine sulfate, melamine pyrophosphate, melam, melem, melon or melamine cyanurate or mixtures thereof.

The melamine cyanurate preferentially suitable according to the invention is a reaction product of preferably equimolar amounts of melamine (formula I) and cyanuric acid/isocyanuric acid (formulae Ia and Ib).

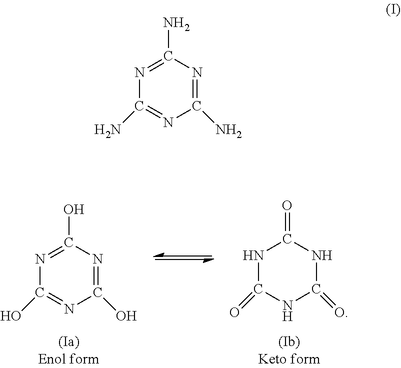 [SMILES: Nc1nc(N)nc(N)n1 ; Oc1nc(O)nc(O)n1 ; O=c1[nH]c(=O)[nH]c(=O)[nH]1]

It is obtained for example by reaction of aqueous solutions of the starting compounds at 90° C. to 100° C. The commercially available product is a white powder having an average grain size d₅₀ of 1.5 to 7 μm and a d₉₉ value of less than 50 μm.

Further suitable compounds (often also described as salts or adducts) are melamine sulfate, melamine, melamine borate, oxalate, phosphate prim., phosphate sec. and pyrophosphate sec., melamine neopentyl glycol borate. According to the invention the molding materials are preferably free from polymeric melamine phosphate (CAS No. 56386-64-2 or 218768-84-4).

This is to be understood as meaning melamine polyphosphate salts of a 1,3,5-triazine compound which have an average degree of condensation number n between 20 and 200 and a 1,3,5-triazine content of 1.1 to 2.0 mol of a 1,3,5-triazine compound selected from the group consisting of melamine, melam, melem, melon, ammeline, ammelide, 2-ureidomelamine, acetoguanamine, benzoguanamine and diaminophenyltriazine per mole of phosphorus atom. Preferably, the n-value of such salts is generally between 40 and 150 and the ratio of a 1,3,5-triazine compound per mole of phosphorus atom is preferably between 1.2 and 1.8. Furthermore, the pH of a 10 wt % aqueous slurry of salts produced according to EP-B1 095 030 will generally be more than 4.5 and preferably at least 5.0. The pH is typically determined by adding 25 g of the salt and 225 g of clean water at 25° C. into a 300 ml beaker, stirring the resultant aqueous slurry for 30 minutes and then measuring the pH. The abovementioned n-value, the number-average degree of condensation, may be determined by means of 31P solid-state NMR. J. R. van Wazer, C. F. Callis, J. Shoolery and R. Jones, J. Am. Chem. Soc., 78, 5715, 1956 discloses that the number of adjacent phosphate groups gives a unique chemical shift which permits clear distinction between orthophosphates, pyrophosphates, and polyphosphates.

Suitable guanidine salts are

| | CAS No. |
|---|---|
| g carbonate | 593-85-1 |
| g cyanurate prim. | 70285-19-7 |
| g phosphate prim. | 5423-22-3 |
| g phosphate sec. | 5423-23-4 |
| g sulfate prim. | 646-34-4 |
| g sulfate sec. | 594-14-9 |
| guanidine pentaerythritol borate | n.a. |
| guanidine neopentyl glycol borate | n.a. |
| and urea phosphate green | 4861-19-2 |
| urea cyanurate | 57517-11-0 |
| ammeline | 645-92-1 |
| ammelide | 645-93-2 |
| melem | 1502-47-2 |
| melon | 32518-77-7 |

In the context of the present invention “compounds” is to be understood as meaning not only for example benzoguanamine itself and the adducts/salts thereof but also the nitrogen-substituted derivatives and the adducts/salts thereof.

Also suitable are ammonium polyphosphate (NH₄PO₃)ₙ where n is about 200 to 1000, preferably 600 to 800, and tris(hydroxyethyl)isocyanurate (THEIC) of formula IV

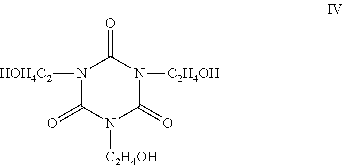

or the reaction products thereof with aromatic carboxylic acids Ar(COOH)ₘ, which may optionally be present in a mixture with one another, wherein Ar represents a monocyclic, bicyclic or tricyclic aromatic six-membered ring system and m is 2, 3 or 4.

Examples of suitable carboxylic acids include phthalic acid, isophthalic acid, terephthalic acid, 1,3,5-benzenetricarboxylic acid, 1,2,4-benzenetricarboxylic acid, pyromellitic acid, mellophanic acid, prehnitic acid, 1-naphthoic acid, 2-naphthoic acid, naphthalenedicarboxylic acids, and anthracenecarboxylic acids.

Production is effected by reaction of the tris(hydroxyethyl)isocyanurate with the acids, the alkyl esters thereof or the halides thereof according to the processes in EP-A 584 567.

Such reaction products are a mixture of monomeric and oligomeric esters which may also be crosslinked. The degree of oligomerization is typically 2 to about 100, preferably 2 to 20. Preference is given to using mixtures of THEIC and/or reaction products thereof with phosphorus-containing nitrogen compounds, in particular (NH₄PO₃)ₙ or melamine pyrophosphate or polymeric melamine phosphate. The mixing ratio for example of (NH₄PO₃)ₙ to THEIC is preferably 90.0 to 50.0:10.0 to 50.0, in particular 80.0 to 50.0:50.0 to 20.0, wt % based on the mixture of such components B1).

Also suitable are benzoguanidine compounds of formula V

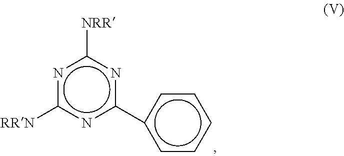

in which R, R′ represents straight-chain or branched alkyl radicals having 1 to 10 carbon atoms, preferably hydrogen, and in particular adducts thereof with phosphoric acid, boric acid and/or pyrophosphoric acid.

Also preferred are allantoin compounds of formula VI,

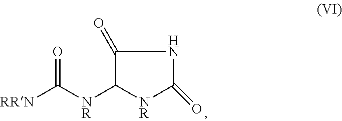

wherein R, R′ are as defined in formula V, and also the salts thereof with phosphoric acid, boric acid and/or pyrophosphoric acid and also glycolurils of formula VII or the salts thereof with the abovementioned acids

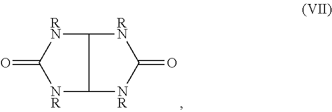

in which R is as defined in formula V.

Suitable products are commercially available or obtainable as per DE-A 196 14 424.

The cyanoguanidine (formula VIII) usable in accordance with the invention is obtainable for example by reacting calcium cyanamide with carbonic acid, the cyanamide produced dimerizing at from pH 9 to pH 10 to afford cyanoguanidine.

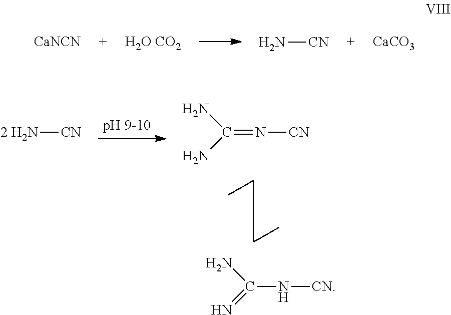

The commercially available product is a white powder having a melting point of 209° C. to 211° C.

It is particularly preferable to employ melamine cyanurate (for example Melapur® MC25 from BASF SE).

It is further possible to employ separate metal oxides such as antimony trioxide, antimony pentoxide, sodium antimonate and similar metal oxides. However it is preferable to eschew the use of such metal oxide since they are already present in component B. For a description of pentabromobenzyl acrylate and antimony trioxide or antimony pentoxide reference may be made to EP-A 0 624 626.

It is also possible to employ phosphorus, for example red phosphorus, as component C. Red phosphorus may for example be employed in the form of a masterbatch.

Also contemplated are dicarboxylic acids of formula

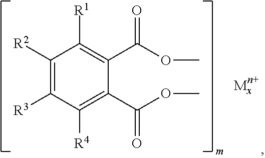

wherein

R¹ to R⁴ independently of one another represent halogen or hydrogen with the proviso that at least one radical R¹ to R⁴ represents halogen,

x=1 to 3, preferably 1, 2

m=1 to 9, preferably 1 to 3, 6, 9, in particular 1 to 3

n=2 to 3

M=alkaline earth metal, Ni, Ce, Fe, In, Ga, Al, Pb, Y, Zn, Hg.

Preferred dicarboxylic acid salts comprise as radicals R¹ to R⁴ independently of one another Cl or bromine or hydrogen, especially preferably all radicals R¹ to R⁴ are Cl or/and Br.

Be, Mg, Ca, Sr, Ba, Al, Zn, Fe are preferred as metals M.

Such dicarboxylic acid salts are commercially available or producible according to the processes described in U.S. Pat. No. 3,354,191.

It is preferable not to employ additional separate metal oxides nor additionally phosphorus or dicarboxylic acid salts.

Also employable as component F are functional polymers. These may be flame retardant polymers for example. Such polymers are described in U.S. Pat. No. 8,314,202 for example and comprise 1,2-bis[4-(2-hydroxyethoxy)phenyl]ethanone repeating units. A further suitable functional polymer for increasing the amount of carbon residue is poly(2,6-dimethyl-1,4-phenyleneoxide) (PPPO).

It is preferable to employ only the flame retardant components B, C and D.

Component F may also be elastomeric polymers (often also described as impact modifiers, elastomers or rubbers).

Very generally these are copolymers preferably constructed from at least two of the following monomers: ethylene, propylene, butadiene, isobutene, isoprene, chloroprene, vinyl acetate, styrene, acrylonitrile and acrylic or methacrylic esters having 1 to 18 carbon atoms in the alcohol component.

Such polymers are described for example in Houben-Weyl, Methoden der organischen Chemie, Vol. 14/1 (Georg-Thieme-Verlag, Stuttgart, 1961), pages 392 to 406 and in the monograph “Toughened Plastics” by C. B. Bucknall (Applied Science Publishers, London, 1977).

Some preferred types of such elastomers are presented hereinbelow.

Preferred types of elastomers are the so-called ethylene-propylene (EPM) and ethylene-propylene-diene (EPDM) rubbers.

EPM rubbers generally have virtually no double bonds left, while EPDM rubbers can have 1 to 20 double bonds/100 carbon atoms.

As diene monomers for EPDM rubbers mention is made for example of conjugated dienes such as isoprene and butadiene and nonconjugated dienes having 5 to 25 carbon atoms, such as penta-1,4-diene, hexa-1,4-diene, hexa-1,5-diene, 2,5-dimethylhexa-1,5-diene and octa-1,4-diene, cyclic dienes such as cyclopentadiene, cyclohexadienes, cyclooctadienes and dicyclopentadiene, and alkenylnorbornenes such as 5-ethylidene-2-norbornene, 5-butylidene-2-norbornene, 2-methallyl-5-norbornene, 2-isopropenyl-5-norbornene and tricyclodienes such as 3-methyltricyclo[5.2.1.0.2.6]-3,8-decadiene and mixtures thereof. Preference is given to hexa-1,5-diene, 5-ethylidenenorbornene and dicyclopentadiene. The diene content of the EPDM rubbers is preferably 0.5 to 50.0 and in particular 1.0 to 8.0 wt % based on the total weight of the rubber.

EPM/EPDM rubbers may preferably also be grafted with reactive carboxylic acids or derivatives thereof. Mention is made here for example of acrylic acid, methacrylic acid and derivatives thereof, for example glycidyl (meth)acrylate, and maleic anhydride.

A further group of preferred rubbers are copolymers of ethylene with acrylic acid and/or methacrylic acid and/or the esters of these acids. The rubbers may additionally comprise monomers comprising dicarboxylic acids such as maleic acid and fumaric acid or derivatives of these acids, for example esters and anhydrides, and/or monomers comprising epoxy groups. These monomers comprising dicarboxylic acid derivatives/epoxy groups are preferably incorporated into the rubber by addition to the monomer mixture of monomers which comprise dicarboxylic acids/epoxy groups and conform to the general formula I or II or III or IV.

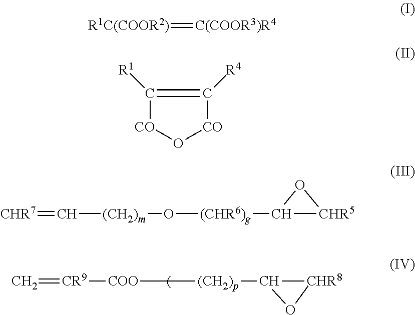

wherein R¹ to R⁹ represent hydrogen or alkyl groups having 1 to 6 carbon atoms, m is an integer from 0 to 20, g is an integer from 0 to 10 and p is an integer from 0 to 5.

It is preferable when the radicals R¹ to R⁹ represent hydrogen, wherein m is 0 or 1 and g is 1. The corresponding compounds are maleic acid, fumaric acid, maleic anhydride, allyl glycidyl ether and vinyl glycidyl ether.

Preferred compounds of formulae I, II and IV are maleic acid, maleic anhydride and esters of acrylic acid and/or methacrylic acid which comprise epoxy groups, such as glycidyl acrylate, glycidyl methacrylate, and the esters with tertiary alcohols, such as t-butyl acrylate. Although the last-mentioned compounds have no free carboxyl groups, their behavior approaches that of the free acids and they are therefore described as monomers with latent carboxyl groups.

The copolymers are advantageously composed of 50 to 98 wt % of ethylene, 0.1 to 20.0 wt % of monomers comprising epoxy groups and/or monomers comprising (meth)acrylic acid and/or anhydride groups, (meth)acrylic esters making up the remainder.

Particular preference is given to copolymers made of
50.0 to 98.0, in particular 55.0 to 95.0, wt % of ethylene,
0.1 to 40.0, in particular 0.3 to 20.0, wt % of glycidyl acrylate and/or glycidyl methacrylate, (meth)acrylic acid and/or maleic anhydride, and
1.0 to 45.0, in particular 10.0 to 40.0, wt % of n-butyl acrylate and/or 2-ethylhexyl acrylate.

Further preferred esters of acrylic and/or methacrylic acid are the methyl, ethyl, propyl and i-/t-butyl esters.

It is additionally possible to employ vinyl esters and vinyl ethers as comonomers.

The abovedescribed ethylene copolymers may be produced by processes known per se, preferably by random copolymerization under high pressure and elevated temperature. Corresponding processes are common knowledge.

Preferred elastomers also include emulsion polymers, the production of which is described, for example, by Blackley in the monograph “Emulsion Polymerization”. The usable emulsifiers and catalysts are known per se.

It is possible in principle to employ elastomers having a homogeneous construction or else elastomers having a shell construction. The shell-like construction is determined by the sequence of addition of the individual monomers; the morphology of the polymers too is influenced by this sequence of addition.

As representative examples only of monomers for producing the rubber part of the elastomers mention is made here of acrylates, for example n-butyl acrylate and 2-ethylhexyl acrylate, corresponding methacrylates, butadiene and isoprene and also mixtures thereof. These monomers may be copolymerized with further monomers, for example styrene, acrylonitrile, vinyl ethers and further acrylates or methacrylates such as methyl methacrylate, methyl acrylate, ethyl acrylate and propyl acrylate.

The soft or rubber phase (having a glass transition temperature of below 0° C.) of the elastomers may constitute the core, the outer sheath or an intermediate shell (for elastomers constructed from more than two shells); multishell elastomers may also have a plurality of shells composed of a rubber phase.

When, in addition to the rubber phase, the construction of the elastomer also involves one or more hard components (having glass transition temperatures of above 20° C.), these are generally produced by polymerization of styrene, acrylonitrile, methacrylonitrile, α-methylstyrene, p-methylstyrene, acrylic esters and methacrylic esters such as methyl acrylate, ethyl acrylate and methyl methacrylate as principal monomers. Smaller proportions of further comonomers may additionally be employed here too.

It has proved advantageous in a number of cases to employ emulsion polymers having reactive groups at the surface. Examples of such groups include epoxy, carboxyl, latent carboxyl, amino or amide groups and also functional groups that may be introduced by co-use of monomers of general formula

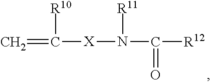

wherein the substituents may have the following meanings:
R¹⁰ hydrogen or a C₁- to C₄-alkyl group,
R¹¹ hydrogen, a C₁- to C₈-alkyl group or an aryl group, in particular phenyl,
R¹² hydrogen, a C₁- to C₁₀-alkyl group, a C₆- to C₁₂-aryl group or —OR¹³
R¹³ a C₁- to C₈-alkyl group or C₆- to C₁₂-aryl group, which may optionally be substituted with oxygen- or nitrogen-containing groups,
X a chemical bond, a C₁- to C₁₀-alkylene or C₆-C₁₂-arylene group or

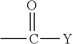

Y O—Z or NH—Z and
Z a C₁- to C₁₀-alkylene or C₆- to C₁₂-arylene group.

The graft monomers described in EP-A 208 187 are also suitable for introducing reactive groups at the surface.

As further examples mention is also made of acrylamide, methacrylamide and substituted esters of acrylic acid or methacrylic acid such as (N-t-butylamino)ethyl methacrylate, (N,N-dimethylamino)ethyl acrylate, (N,N-dimethylamino)methyl acrylate and (N,N-diethylamino)ethyl acrylate.

The particles of the rubber phase may moreover also be in a crosslinked state. Examples of crosslinking monomers include 1,3-butadiene, divinylbenzene, diallyl phthalate and dihydrodicyclopentadienyl acrylate and also the compounds described in EP-A 502 65.

It is also possible to employ so-called graft-linking monomers, i.e. monomers having two or more polymerizable double bonds which react at different rates during the polymerization. It is preferable to employ compounds where at least one reactive group polymerizes at about the same rate as the other monomers, while the other reactive group (or reactive groups) for example polymerize(s) markedly more slowly. The different polymerization rates give rise to a certain proportion of unsaturated double bonds in the rubber. When another phase is then grafted onto a rubber of this type, at least some of the double bonds present in the rubber react with the graft monomers to form chemical bonds, i.e., the phase grafted on has at least some degree of chemical bonding to the grafting base.

Examples of such graft-linking monomers include monomers comprising allyl groups, in particular allyl esters of ethylenically unsaturated carboxylic acids such as allyl acrylate, allyl methacrylate, diallyl maleate, diallyl fumarate, diallyl itaconate or the corresponding monoallyl compounds of these dicarboxylic acids. There are additionally a great many further suitable graft-linking monomers; see U.S. Pat. No. 4,148,846 for example for further details.

These crosslinking monomers are generally present in the impact-modifying polymer in proportions of up to 5.0 wt % and preferably not more than 3.0 wt % based on the impact-modifying polymer.

A number of preferred emulsion polymers are listed below. The list first mentions graft polymers having a core and at least one outer shell, which have the following construction:

| Type | Monomers for core | Monomers for sheath |
|---|---|---|
| I | 1,3-butadiene, isoprene, | styrene, acrylonitrile, |
| | n-butyl acrylate, ethylhexyl | methyl methacrylate |
| | acrylate or mixtures thereof | |
| II | as I, but with co-use of | as I |
| | crosslinkers | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with co-use of |
| | | monomers having reactive groups |
| | | as described herein |
| V | styrene, acrylonitrile, | first sheath made of monomers as |
| | methyl methacrylate or | described under I and II for the |
| | mixtures thereof | core second sheath as described |
| | | under I or IV for the sheath |

These graft polymers, in particular ABS and/or ASA polymers in amounts up to 40.0 wt % are preferably employed for impact modifying of PBT optionally in admixture with up to 40.0 wt % of polyethylene terephthalate. Corresponding blend products are obtainable under the trademark Ultradur®S (previously Ultrablend®S of BASF AG).

Instead of graft polymers having a multishell construction, it is also possible to use homogeneous, i.e., single-shell, elastomers made of 1,3-butadiene, isoprene and n-butyl acrylate or copolymers thereof. These products too may be prepared by co-use of crosslinking monomers or monomers having reactive groups.

Examples of preferred emulsion polymers include n-butyl acrylate-(meth)acrylic acid copolymers, n-butyl acrylate-glycidyl acrylate or n-butyl acrylate-glycidyl methacrylate copolymers, graft polymers having an inner core made of n-butyl acrylate or based on butadiene and an outer sheath of the abovementioned copolymers, and copolymers of ethylene with comonomers which provide reactive groups.

The elastomers described may also be prepared by other customary methods, for example by suspension polymerization.

Silicone rubbers as described in DE-A 37 25 576, EP-A 235 690, DE-A 38 00 603 and EP-A 319 290 are likewise preferred.

It will be appreciated that it is also possible to employ mixtures of the rubber types cited hereinabove.

Production of the thermoplastic molding materials according to the invention and of the mixture for imparting flame retardant properties is effected by mixing the ingredients.

The thermoplastic molding materials are used for producing molded articles, fibers or films and are produced by melting, extruding and subsequent molding of the thermoplastic molding material.

Molded articles are preferably (electrical) switches, plugs, connectors and housings for electronic or electric parts.

The thermoplastic molding materials according to the invention may be prepared by known processes, by mixing the starting components in customary mixing apparatuses and subsequently extruding the resulting mixture. Suitable processing machines are described in: Handbuch der Kunststoffextrusion, Vol. 1 Grundlagen, Editors F. Hensen, W. Knappe, H. Potente, 1989, pages 3 to 7 (ISBN 3-446-14339-4) and in Vol. 2 Extrusionsanlagen, 1986 (ISBN 3-446-14329-7). After extrusion, the extrudate may be cooled and comminuted. It is also possible to premix individual components and then add the remaining starting materials individually and/or likewise in the form of a mixture—or as concentrates in a carrier polymer (masterbatch). The mixing temperatures are generally in the range from 230 to 320° C.

The invention is more particularly elucidated by the examples which follow.

### EXAMPLES

Input materials:

| | | |
|---|---|---|
| A | PA66 | VZ 120 cm³/g, |
| | | Ultramid ®A24, BASF SE |
| | polyamide 6 | VZ 150 cm³/g, |
| | | Ultramid ®B27, BASF SE |
| | PA6I/6T | Selar ® A 3426, DuPont |
| B | cyclophosphazene | Rabitle ® FP 110, |
| | | Fushimi Co. |
| C | aromatic polyphosphate | PX-200, Daihachi Chemical |
| D | aluminum diethylphosphinate salt | e.g. Exolit ® OP 1230, |
| | (DEPAL) | Clariant AG |
| E | glass fiber | OCF DS 1110 |
| F | melamine poly(aluminumphosphate) | Satire ® 400 |
| | melamine polyphosphate (MPP) | Melapur ® M200, |
| | | BASF Schweiz |
| | | (only in comparative |
| | | examples) |

Processing:

The individual components were mixed in a twin-screw extruder (ZSK 25) at a throughput of about 20 kg/h and about 280° C. (PA66) at a flat temperature profile, extruded, cooled until pelletizable and pelletized. The test specimens for the investigations set out in the tables were injection molded on an Arburg 420 injection molding machine at a melt temperature of about 260 to 280° C. and a mold temperature of about 80° C.

The compositions of the molding materials and the results of the measurements may be found in the tables.

Testing:

The mechanical properties were determined according to ISO 527-2/1A/5 and Charpy impact strength (unnotched) was determined according to ISO 179-2/1eU.

The flame retardancy of the molding materials was firstly determined according to method UL94-V (Underwriters Laboratories Inc. Standard of Safety, “Test for Flammability of Plastic Materials for Parts in Devices and Appliances”, Northbrook 1998, page 14 to page 18).

Glow wire test:

Glow wire tests were performed according to DIN EN 60695-2-11/-12/-13 (edition valid in March 2017). As a criterion for the test on the component part, a plug in this case, reported in the examples it was observed in accordance with IEC 60335-1 whether flame formation is visible for a period of >2 s. The temperature reported in the examples is the maximum glow wire temperature at which no flame formation occurred.

A plug which may be regarded as typical for the relevant product class was used as the component part in the examples by way of example. The plug comprises sections of different wall thickness (0.8 mm in thin places, 2 mm in thick places and has external dimensions of 23 mm×10 mm×17 mm). The plugs were produced with molding materials according to the invention and exhibit no dark spots.

TGA:

Thermogravimetric analysis was performed with a TA Instruments Q5000IR instrument. The sample mass was 2 mg to 3 mg. Samples were weighed in aluminum crucibles and the material was heated from 40° C. to 600° C. at a constant heating rate of 20° C. min⁻¹ under nitrogen flow.

### Examples I

| | 1 | 2 | 3 | C1 | C2 | C3 | C4 | C5 | C6 | C7 | C8 |
|---|---|---|---|---|---|---|---|---|---|---|---|
| Ultramid A24 | 44 | 39 | 32 | 33.5 | 45 | 37 | 35 | 36 | 43 | 35.6 | 45 |
| Selar PA 3426 | 8 | 13 | 7 | 7.0 | 0 | 7 | 15 | 7 | 8 | 7.1 | 8 |
| Ultramid B22 | 0 | 0 | 5 | 4.5 | 0 | 5.0 | 0 | 5 | 0 | 4.7 | 0 |
| Glass fiber DS | 30 | 30 | 30 | 30 | 30 | 30 | 25 | 30 | 30 | 30 | 30 |
| 1110 | | | | | | | | | | | |
| Melapur 200 | 0 | 0 | 0 | 3 | 3 | 0 | 16.7 | 0 | 3 | 3 | 0 |
| Safire 400 | 0 | 0 | 0 | 0 | 0 | 3 | 0 | 0 | 0 | 0 | 0 |
| Rabitle FP-110 | 3 | 3 | 5 | 6 | 6 | 5 | 8.3 | 6 | 0 | 3.6 | 0 |
| Exolit OP 1230 | 12 | 12 | 13 | 16 | 16 | 13 | 0 | 16 | 16 | 16 | 12 |
| PX-200 | 3 | 3 | 5 | 0 | 0 | 0 | 0 | 0 | 0 | 0 | 5 |
| Modulus of elastici- | 9900 | 10050 | 9300 | 9950 | 9600 | 10500 | 9400 | 9900 | 8800 | 10300 | 10500 |
| ty (MPa) | | | | | | | | | | | |
| Elongation at break | 3.0 | 3.2 | 2.2 | 3.0 | 2.6 | 2.7 | 2.7 | 2.7 | 2.7 | 3.3 | 3.0 |
| (%) | | | | | | | | | | | |
| Charpy aCU | 75 | 75 | 32 | 66 | 51 | 37 | 53 | 64 | 66 | 72 | 78 |
| (kJ/m²) | | | | | | | | | | | |
| GWT testing on | 750 | 750 | 775 | 750 | 750 | 750 | 750 | 725 | 725 | 725 | 725 |
| plug. Max. tem- | | | | | | | | | | | |
| perature (° C.) with- | | | | | | | | | | | |
| out ignition | | | | | | | | | | | |
| GWIT 2 mm sheet | — | — | — | 800 | — | — | 875 | — | — | — | |
| UL V-94 0.8 mm | V-0 | V-0 | V-0 | V-0 | V-0 | V-0 | C2 | V-0 | V-0 | V-0 | V-0 |
| UL V-94 0.4 mm | V-0 | V-0 | V-0 | V-0 | V-0 | V-0 | — | V-0 | V-0 | V-0 | C1 |
| Visual appearance | Light- | Light- | Light- | Black | Black | Black | Light- | Light- | Black | Black | Light- |
| | colored, | colored, | colored, | marks | marks | spots | colored, | colored, | marks | marks | colored, |
| | homoge- | homoge- | homoge- | | | | homoge- | few marks | | | homoge- |
| | neous | neous | neous | | | | neous | | | | neous |

— no values available

As shown in the examples both the glow wire test on the sheet and on the component part and the UL 94 test at 0.4 mm wall thickness can be passed with a combination of phosphinates, cyclophosphazene and melamine polyphosphate (MPP) (comparative examples C1, C2). However the samples exhibit black planar colorations and also black spots. The dark colorations indicate an incompatibility of cyclophosphazene with melamine polyphosphates. Substitution of pure MPP with a modified melamine polyphosphate cannot achieve significant improvement (comparative example C3). Sheetlets (60 mm×60 mm×2 mm) produced by injection molding of an inventive molding material (1) and a noninventive molding material (C3) show by way of example a uniform light-colored surface for molding material (1) and gray streaks and a grayer coloration for molding material (C3). Molding materials comprising a large amount of MPP and cyclophosphazene can achieve very good resistance to the glow wire (comparative example C4) and the effect of MPP as a light-colored filler results in an attractive surface of the material. However a pass cannot be achieved in the vertical UL 94 test with such samples even at a wall thickness of 0.8 mm.

In turn, in formulations comprising cyclophosphazene without addition of MPP a pass cannot be achieved in the glow wire test at 750° C. (comparative example C5). Likewise, the addition of MPP without cyclophosphazene does not result in a pass in the glow wire test at 750° C. (comparative example C6). A reduced addition of the combination of MPP and cyclophosphazene likewise cannot result in a pass in the glow wire test at 750° C. (comparative example C7) and the dark coloration remains present.

In accordance with the invention all requirements of the glow wire and UL 94 test are achieved by combinations of cyclophosphazene, phosphinate and a phosphate ester (examples 1 to 3). The samples exhibit a homogeneous surface without colorations. If the phosphate ester is used without addition of the cyclophosphazene the molding materials exhibit too low a resistance to the glow wire and can achieve only a UL 94 V1 classification at a wall thickness of 0.4 mm (comparative example C8). The inventive molding materials 1 and 2 in particular exhibit not only good flame retardancy but also a very good impact strength.

1. A thermoplastic molding material comprising
a) 25.0 to 64.5 wt % of at least one thermoplastic polyamide as component A,
b) 2.0 to 8.0 wt % of at least one phosphazene of general formula (IX) or (X) 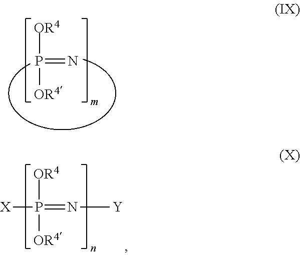
in which m is an integer from 3 to 25 and R⁴ and R⁴′ are identical or different and represent C₁-C₂₀-alkyl-, C₆-C₃₀-aryl-, C₆-C₃₀-arylalkyl- or C₆-C₃₀-alkyl-substituted aryl or linear phosphazenes of general formula (X),
n represents 3 to 1000 and X represents —N═P(OPh)₃ or —N═P(O)OPh and Y represents —P(OPh)₄ or —P(O)(OPh)₂,
as component B,
c) 1.5 to 6.0 wt % of at least one aliphatic or aromatic ester of phosphoric acid or polyphosphoric acid as component C,
d) 5.0 to 30.0 wt % of at least one metal phosphinate or phosphinic acid salt of general formula (I) or diphosphinic acid salt of general formula (II) or polymers thereof 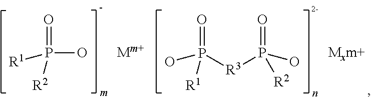
in which
R¹, R² are identical or different and represent hydrogen, C₁-C₆-alkyl, linear or branched, and/or aryl;
R³ represents C₁-C₁₀-alkylene, linear or branched, C₆-C₁₀-arylene, -alkylarylene or -arylalkylene;
M represents Mg, Ca, Al, Sb, Sn, Ge, Ti, Zn, Fe, Zr, Ce, Bi, Sr, Mn, Li, Na, K and/or a protonated nitrogen base;
m=1 to 4; n=1 to 4; x=1 to 4, preferably m=3, x=3, as component D,
e) 26.0 to 65.0 wt % of glass fibers as component E,
f) 0 to 10.0 wt % of further assistants as component F,
wherein the total of components A to E sums to 100.0 wt %.

2. The thermoplastic molding material according to claim 1, wherein a cyclic phenoxyphosphazene having at least 3 phenoxyphosphazene units is employed as component B.

3. The thermoplastic molding material according to claim 1, wherein component C is selected from aromatic polyphosphates.

4. The thermoplastic molding materials according to claim 1, wherein in component D R¹, R² are identical or different and represent hydrogen, methyl, ethyl, n-propyl, isopropyl, n-butyl, tert.-butyl, n-pentyl and/or phenyl and R³ represents methylene, ethylene, n-propylene, isopropylene, n-butylene, tert-butylene, n-pentylene, n-octylene or n-dodecylene, phenylene or naphthylene; methylphenylene, ethylenephenylene, tert-butylphenylene, methylnaphthylene, ethylnaphthylene or tert-butylnaphthylene; phenylmethylene, phenylethylene, phenylpropylene or phenylbutylene.

5. The thermoplastic molding material according to according to claim 1, wherein component A is a blend of at least one aliphatic polyamide and at least one semiaromatic or aromatic polyamide.

6. The thermoplastic molding material according to claim 1, wherein component B is employed in an amount of 2.0 to 6.0 wt %, preferably 3.0 to 5.0 wt %, based on the total of components A to E which sums to 100%.

7. The thermoplastic molding material according to according to claim 1, wherein 2.5 to 5.5 wt %, preferably 3.0 to 5.0 wt %, of at least one aliphatic or aromatic ester of phosphoric acid or polyphosphoric acid are employed as component C.

8. A process for producing thermoplastic molding materials according to according to claim 1 by mixing the ingredients.

9. (canceled)

10. A molded article, fiber or film made of a thermoplastic molding material according to according to claim 1.

11. A process for producing molded articles, fibers or films made of a thermoplastic molding material according to claim 1 by melting, extruding and subsequent molding of a thermoplastic molding material according to claim 1.

12. (canceled)

13. (canceled)
